(19) United States
(12) Patent Application Publication
(10) Pub. No.: US 2010/0077433 A1
(43) Pub. Date: Mar. 25, 2010

(54) MULTI-PANEL TELEVISION BROWSING

(75) Inventor: Syed Zafar BEYABANI, Irving, TX (US)

Correspondence Address: VERIZON;PATENT MANAGEMENT GROUP, 1320 North Court House Road, 9th Floor, ARLINGTON, VA, 22201-2909, US

(73) Assignee: Verizon Data Services LLC, Temple Terrace, FL (US)

(21) Appl. No.: 12/236,612

(22) Filed: Sep. 24, 2008

(51) Int. Cl. H04N 5/445; H04N 7/173

(52) U.S. Cl. 725/43; 725/131

(57) ABSTRACT

A method includes displaying program content from a subscription television service on a display and receiving a signal to initiate a multi-panel browsing mode on the display. The method further includes sending, to a server, a top program request for the subscription television service and receiving top program information from the server based on the top program request, the top program information including a channel number for a top program at a time associated with the top program request. The method also includes displaying a multi-panel view on the display, the multi-panel view including a panel with the program content and a panel with the top program based on the top program information received from the server. Additional panels included in the multi-panel view may include interactive games or other content available from the subscription television service.

### BACKGROUND INFORMATION

The proliferation of channels for subscription television (such as cable, optical fiber, or satellite subscriptions) can provide viewers with numerous viewing options. Programming with interruptions (such as advertising) and/or delays (such as in live-action events) may cause typical viewers to begin browsing through other channels with the intention of returning to the original programming when the interruption and/or delay is over.

### BRIEF DESCRIPTION OF THE DRAWINGS

FIGS. 1A and 1B illustrate an exemplary system that provides multi-panel television browsing according to implementations described herein;

FIG. 2 depicts an exemplary system in which concepts described herein may be implemented;

FIG. 3 is a block diagram of exemplary components of a set-top box that may be used in the system of FIG. 2;

FIG. 4 is a functional block diagram of the exemplary set-top box of FIG. 3;

FIG. 5 is a block diagram of exemplary components of a server that may be used in the system of FIG. 2;

FIG. 6 is a process flow illustrating exemplary operations that may be performed by the set-top box to provide multi-panel television browsing;

FIG. 7 is an exemplary diagram illustrating an implementation of multi-panel browsing according to systems and/or methods described herein; and

FIG. 8 is a diagram illustrating exemplary menu options for multi-panel browsing according to systems and/or methods described herein.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Systems and/or methods described herein may permit a user of a subscription television service to view multiple panels on a display in addition to a current program. In one implementation, for example, if a user selects a multi-panel mode on a set-top box, the display may be divided so that the current program may be viewed along with one or more options for additional subscription television content. The options for addition subscription television content may be based on user-defined criteria or other criteria that identifies, for example, a top program, gaming content, video-on-demand (VOD) options, etc. A user may select audio and/or other functionality for any one of the displayed panels.

As used herein, the term “set-top box” or “STB” may refer to any media processing system that may receive multimedia content over a network and may provide such multimedia content to an attached television. Also, as used herein, the terms “user,” “viewer,” and “customer” may refer interchangeably to a person who views, listens, or plays a multimedia program, video, and/or music (e.g., provided via a STB). A program generally corresponding to particular criteria stored in the STB may be referred to herein as a “top program.”

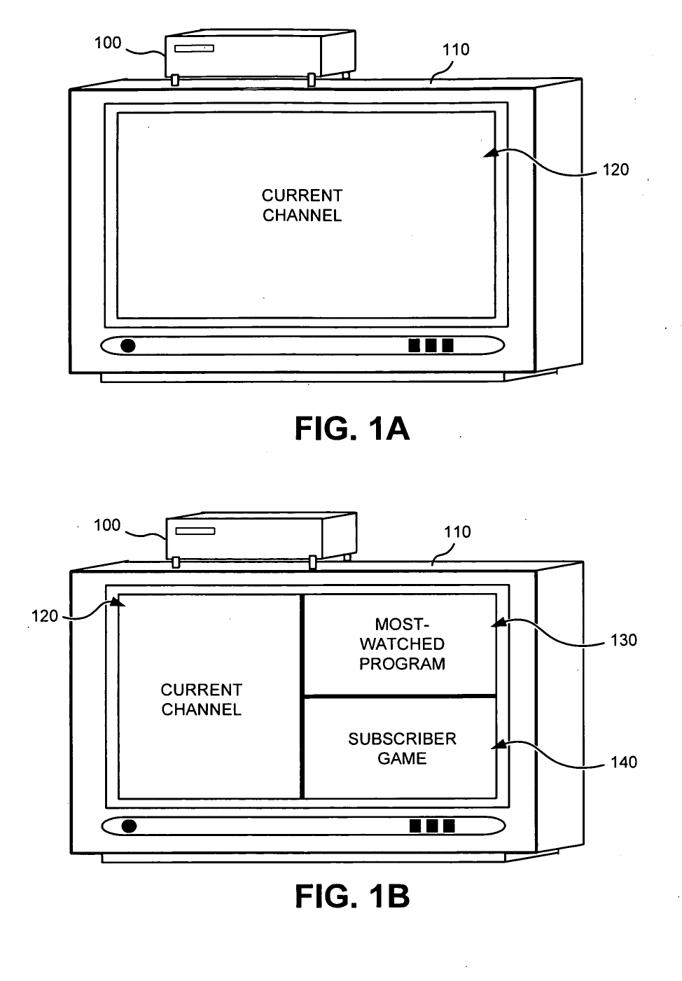

FIGS. 1A and 1B illustrate an exemplary system that provides multi-panel television browsing according to implementations described herein. Referring to collectively to FIGS. 1A and 1B, a set-top box 100 may receive multimedia content over a network (not shown in FIGS. 1A and 1B). The content may be presented to the user on a display, such as television 110. As shown in FIG. 1A, a user may typically view a single program (e.g., a primary panel 120) of a current channel on the entire display of television 110. However, when interruptions to programming (e.g., advertisements, delays in live programming, etc.) occur on the current channel, a user may begin tuning to other channels. Thus, a user may not be aware when the interruptions to the programming on the current channel are over. Also, the user may miss advertisements targeted toward viewers of the programming provided on the current channel. Instead, the user may enter a multi-panel browsing mode to explore other view options while the current channel on primary panel 120 remains visible.

Referring to FIG. 1B, an implementation of the multi-panel browsing mode is shown. The display size of primary panel 120 may be reduced to allow the display of a second viewing panel 130 and a third viewing panel 140. Each of panels 120, 130, and 140 may simultaneously display different multimedia content according to pre-defined criteria. For example, the primary panel 120 may continue to display the current channel selected by the user. Second viewing panel 130 may automatically tune to the most-watched program at the current time. Third viewing panel 140 may automatically display a particular interactive game or an interactive game menu. In other implementations, additional or alternative panels may be shown. Additional or alternative panels may include, for example, VOD previews and/or randomly-generated channel selections. In one implementation, criteria for one or more of panels 120, 130, and 140 may be specified by the user. A user may select audio and/or user-functionality for any one of panels 120, 130 or 140 by sending a command to set-top box 100 (e.g., via remote control, not shown).

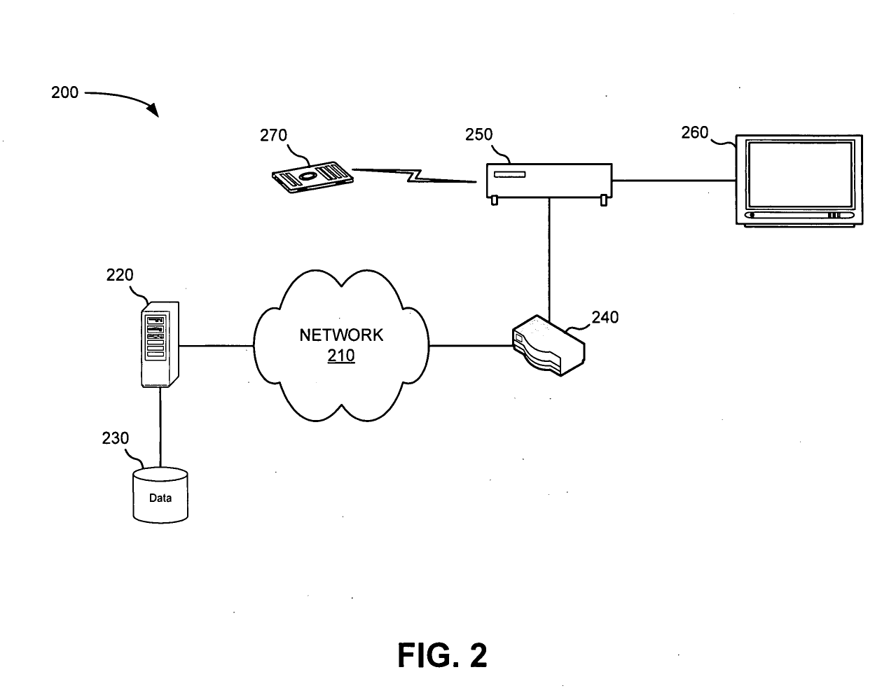

FIG. 2 is a diagram of an exemplary system 200 in which concepts described herein may be implemented. As illustrated, system 200 may include a network 210 that connects a server 220 to a local gateway 240, a STB 250, and a television 260 that may be located on a customer's premises. In general, server 220 may provide or provide control over, via network 210, telecommunication services provided on devices such as television 260 and/or other network connectivity devices (e.g., Internet and telephone, not shown) provided on the customer's premises. Server 220 may connect to a database 230. STB 250 and television 260 may receive signals from a remote control 270. Components of system 200 may interconnect via wired and/or wireless connections.

Network 210 may include a local area network (LAN), a wide area network (WAN), such as a cellular network, a satellite network, or the Internet, a private WAN, or a combination of the Internet and a private WAN, etc. that is used to transport data. Although shown as a single element in FIG. 2, network 210 may include a number of separate networks that function to provide services to devices, such as television 260, at a customer's premises. In one implementation, network 210 may terminate at the customer's premises via an optical communication link, such as an optical fiber provided to the customer's premises. In another possible implementation, network 210 may terminate at the customer's premises via a coaxial cable. In still another implementation, network 210 may terminate at the customer's premises via a wireless (e.g., satellite) connection.

Server 220 may include one or more devices for providing content/information to STB 250 and/or television 260 in accordance with commands that are issued from STB 250. Examples of server 220 may include a headend device that provides broadcast television programs, a video-on-demand device that provides television programs upon request, and a program guide information server that provides information related to television programs available to STB 250. Server 220 may also receive information from one or more STBs, such as recorded information from STB 250 that may include viewing/interaction histories tracked by STB 250. Server 220 may store the information from the STBs in, for example, a database, such as database 230.

Database 230 may maintain entries relating to subscribers' viewing histories and/or other interactions (e.g., game playing, etc.). For example, database 230 may store information that server 220 receives from one or more STBs. In one implementation, database 230 may include exemplary fields, such as, a user-identification field, a date field, a time field, a channel field, and a program/game identification field. While only one database is shown in FIG. 2, database 230 may consist of multiple databases stored locally at server 220 and/or stored at one or more different and possibly remote locations. Database 230 may maintain additional or different information relating to programs watched or games played by viewers. In another implementation, for example, the date field, the time field, the channel field, and/or the program identification field may be replaced with a single field that stores an identifier that represents the date, time, channel, and identification of a program to which a STB (such as STB 250) was tuned.

Gateway 240 may include a network device that provides an interface from network 210 to television 260 and other network connectivity devices (not shown). For example, when telecommunication services are provided to the customer's premises via optical fiber, gateway 240 may include an optical network terminal (ONT) that connects to the optical fiber. The ONT may convert between signals appropriate for television 260 and signals appropriate for transmission over optical fiber. For example, the ONT may include a coaxial cable that leads to television 260 or STB 250. The ONT may also include an Ethernet output port that connects to a personal computer or a VoIP telephone and/or a standard telephone port for connecting to a standard telephone.

Gateway 240 may include one of a number of possible gateway devices, including a satellite antenna, a coaxial cable connection, an ONT, or a broadband access for Internet protocol TV (IPTV). The satellite antenna and receiver may provide an interface for television service broadcast from satellites. The coaxial cable connection may provide an interface for television service connected to a consumer via coaxial cables. The ONT may provide an interface for an optical fiber connection. The broadband IPTV access may include any device that provides broadband access over which television service may be provided.

STB 250 may include a device for selecting and/or obtaining content that may be shown or played on television 260. STB 250 may receive a television signal from gateway 240, convert the signal to a form usable by television 260, and transmit the signal to television 260 for display. STB 250 may further allow a user to alter and/or interact with the content provided to television 260 based on a signal (e.g., a channel up or channel down signal, a function signal, etc.) from, for example, remote control 270. STB 250 may also be capable of sending data to server 220.

In one implementation, STB 250 may track information relating to programs or other content provided to television 260. In another implementation, STB 250 may track information relating to programs output to other devices (not shown), such as a video cassette recorder (VCR), a digital video recorder (DVR), an external storage device, or a remote streaming video viewing device. STB 250 may provide some or all of the tracked information to a server, such as server 220. STB 250 may also obtain tracked information and provide the obtained program viewing information to television 260. In some implementations, STB 250 may obtain tracked program viewing information from an internal memory or from server 220.

Television 260 may include a digital or analog television through which a user may watch programming. Television 260 may refer to any device that can receive and display multimedia content delivered over network 210 for perception by users. Television 260 may include technologies such as cathode ray tube (CRT) displays, liquid crystal displays (LCDs), light-emitting diode (LED) displays, plasma displays and any attendant audio generation facilities.

Remote control 270 may include a device for issuing wireless commands to and for controlling electronic devices (e.g., television 260, STB 250, a stereo system, a digital video disc (DVD) player, etc.). In different implementations, in place of remote control 270, other types of devices (e.g., a wireless keyboard, a mouse, a handheld device (e.g., cell phone), etc.) may be used to control the electronic devices.

In implementations described herein, a user may send a signal (e.g., via a remote control 270) to STB 250 to enter a multi-panel browsing mode. STB 250 may split the display on television 260 into multiple panels, retrieve criteria (which may be either pre-set criteria or user-specified criteria) for each of the panels, and send a query message via network 210 to server 220 to provide information and/or programming content consistent with the criteria for each panel being displayed in the multi-panel browsing mode. Server 220 may respond to the query message by sending to STB 250 (via network 210) information consistent with the query. For example, based on information stored in database 230, server 220 may send to STB 250 the channel of a most-watched program for the current time and/or the identity of a particular game. STB 250 may receive the information from server 220 and automatically tune the individual panels to channels based on the information from server 220.

A single network 210, server 220, database 230, gateway 240, STB 250, and television 260 have been illustrated in FIG. 2 for simplicity. In practice, there may be more or fewer networks, servers, databases, gateways, STBs, and/or televisions. Also, in some instances, one or more of network 210, server 220, database 230, gateway 240, STB 250, and/or television 260 may perform one or more functions described as being performed by another of network 210, server 220, database 230, gateway 240, STB 250, and/or television 260. In one exemplary implementation, television 260 and STB 250 may be connected through one or more audio/video (AV) devices (not shown), such as an audio/video receiver, a video amplifier, video switches, a videocassette recorder (VCR), and/or a digital video disc (DVD) players. In general, AV devices may include any audio or video equipment that a customer installs to provide additional audio/video capabilities or to enhance the capabilities of existing equipment.

Additionally, although only a single STB 250 and television 260 are shown in FIG. 2, any particular customer's premises may include a number of devices capable of displaying multimedia content. Further, although a television for a single customer's premises is shown in FIG. 2, server 220 may interact with many customers' premises and/or their televisions.

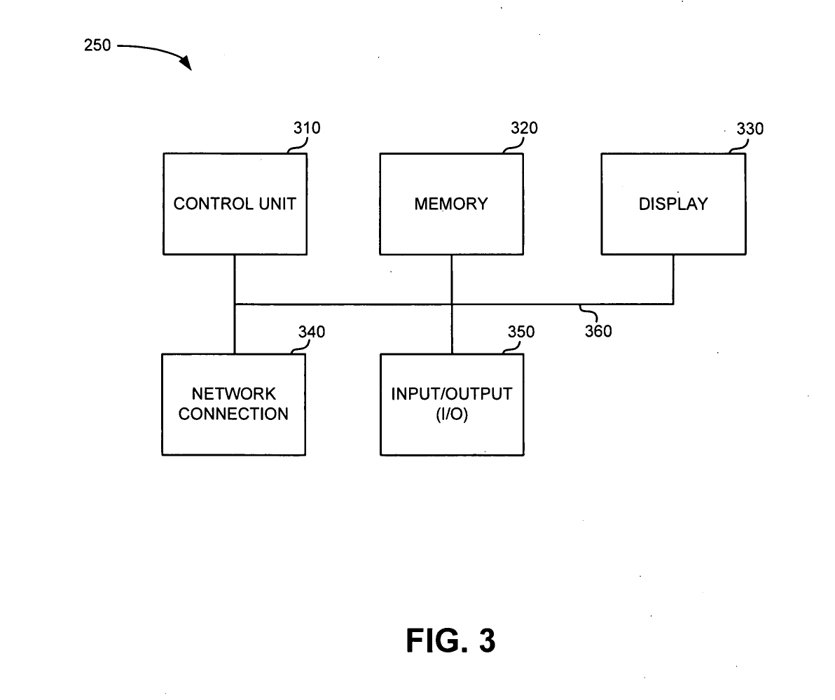

FIG. 3 is diagram illustrating exemplary components of STB 250. As shown, STB 250 may include a control unit 310, memory 320, a display 330, a network connection 340, an input/output (I/O) component 350, and a bus 360.

Control unit 310 may include a processor, microprocessor, or other type of processing logic that may interpret and execute instructions. Among other functions, control unit 310 may collect and store local viewing histories associated with television programming. Control unit 310 may execute instructions to display multi-panel views and retrieve program ranking information from another device, such as server 220. Control unit 310 may also receive information and/or instructions from other devices, such as server 220.

Memory 320 may include a dynamic or static storage device that may store information and instructions for execution by control unit 310. For example, memory 320 may include a storage component, such as a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory. In one implementation, memory 320 may store user preferences for a most-watched program category and/or game types to be used in a multi-panel browsing mode. Most-watched program categories and/or game types may be selected, for example, based on available multimedia content and classifications determined by the subscription television provider.

Display 330 may include any component capable of providing visual information. For example, in one implementation, display 330 may be a light emitting diode (LED) or a liquid crystal display (LCD). In another implementation, display 330 may use another display technology, such as a dot matrix display, etc. Display 330 may display, for example, text (such as a time, a date or a channel selection), image, and/or video information. Display 330 may be an optional component.

Network connection 340 may include any transceiver-like mechanism that enables STB 250 to communicate with other devices and/or systems. For example, network connection 340 may include an Ethernet interface, an optical interface, a coaxial interface, a radio interface, or the like. Network connection 340 may allow for wired, wireless, and/or optical communication. Network connection 340 may be configured to connect STB 250 to a packet-based IP network.

Input/output devices 350 may include user input devices such as external buttons and output devices such as a display or printer. With input/output devices 350, a user may interact with STB 250. In some implementations, input/output devices 350 may be implemented via a remote control, such as remote control 270 of FIG. 2. Bus 360 may provide an interface through which components of STB 250 can communicate with one another.

As will be described in detail below, STB 250 may perform certain operations related to enabling multi-panel browsing in accordance with user preferences. STB 250 may perform these operations in response to control unit 310 executing software instructions contained in a computer-readable medium, such as memory 320. A computer-readable medium may be defined as a physical or logical memory device. The software instructions may be read into memory 320 from another computer-readable medium or from another device. The software instructions contained in memory 320 may cause control unit 310 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 illustrates exemplary components of STB 250, in other implementations, STB 250 may include fewer, additional, and/or different components than those depicted in FIG. 3. In still other implementations, one or more components of STB 250 may perform one or more other tasks described as being performed by one or more other components of STB 250.

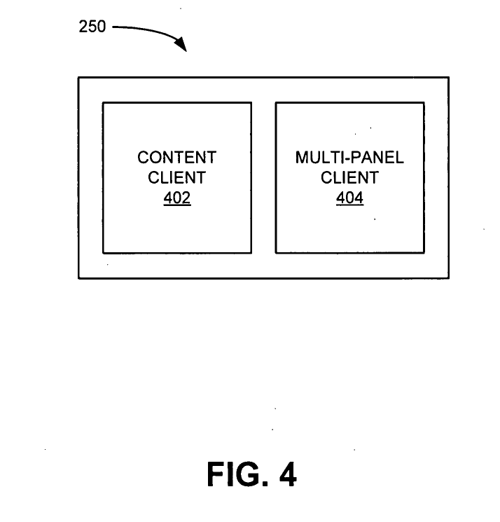

FIG. 4 is a functional block diagram of STB 250. As shown, STB 250 may include a content client 402 and a multi-panel client 404. Depending on the implementation, STB 250 may include additional components. Furthermore, in some implementations, functionalities of content client 402 and multi-panel client 404 may be organized as one component or more than two components.

Content client 402 may include hardware, software, and/or a combination of hardware and software for outputting multimedia content/data that is received from a content distribution system, such as server 220, to television 260. Content client 402 may receive audio/video data, and, based on the received audio/video data, may generate audio/video signals that are directed to television 260. Content client 402 may also receive other multimedia information, such as interactive gaming content, and, based on the other multimedia information, may generate audio and/or video signals that are directed to television 260. Content client 402 may be implemented as a stand-alone application or as part of another component, such as a browser (not shown).

Multi-panel client 404 may include hardware, software, and/or a combination of hardware and software for sending a request for most-watch program and/or game information to server 220 upon activation of the multi-panel browser mode. Multi-panel client 404 may also aid content client 402 in presenting a program or other multimedia content in a panel of the display of television 260 (such as panels 120, 130, and/or 140 of FIG. 1). Multi-panel client 404 may solicit and receive user preferences for one or more panels in the multi-panel browser mode.

In aiding content client 402 to present a multi-panel browsing mode, multi-panel client 404 may provide, to content client 402, parameters that are related to each panel (e.g., locations/sizes/shapes of panels, etc.). Content client 402 may use the parameters to display the user's current program along with other panels that may include programming according to pre-defined criteria, such a most-watched program and/or an interactive game menu. Depending on the implementation, STB 250 may automatically set such parameters, or alternatively, multi-panel client 404 may provide a user interface via which the viewer may input/edit the parameters.

When a user presses a button on a remote control (such as remote control 270 of FIG. 2) to activate the multi-panel browsing mode, multi-panel client 404 may send a request to server 220 to identify a program corresponding to the criteria for one or more panels. Multi-panel client 404 may also identify, to content client 402, which content to display in which panel. In one implementation, multi-panel client 404 may generate a menu interface to collect and store user criteria for each panel. In another implementation, criteria for each panel may be defined by the subscription television provider.

In one implementation, multi-panel client 404 may allow a user to selectively activate an audio signal (and other functionality) for a panel by using a remote control. For example, a remote control may include an “A,” a “B,” and a “C” shortcut buttons, where pressing each button may activate an audio signal for a corresponding panel. As another example, arrow keys on a remote control may be used to selectively switch audio between panels.

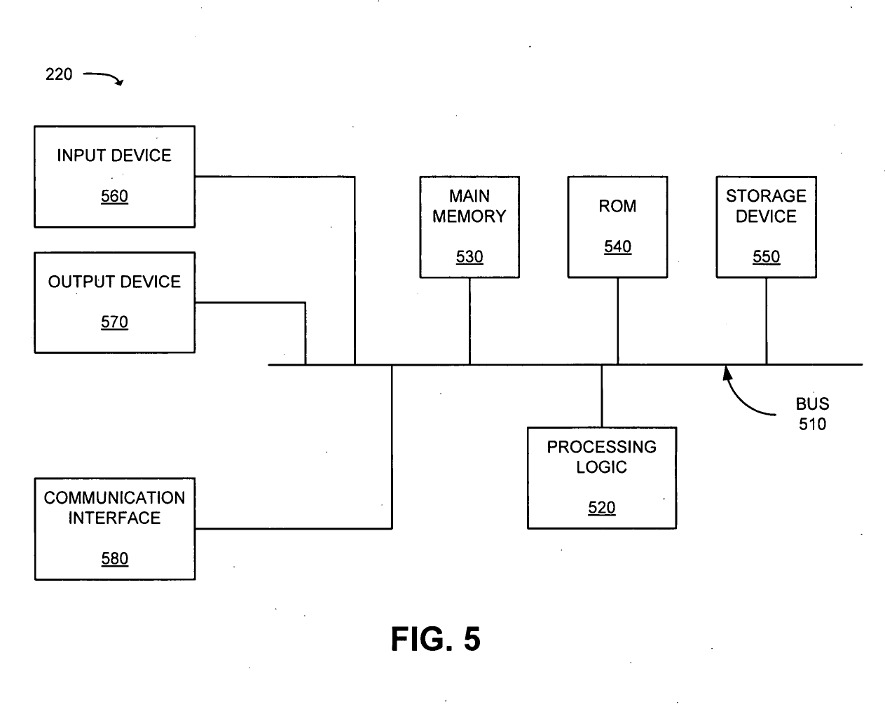

FIG. 5 is a diagram of exemplary components of server 220. As illustrated, server 220 may include a bus 510, processing logic 520, a main memory 530, a ROM 540, a storage device 550, an input device 560, an output device 570, and a communication interface 580. In other implementations, server 220 may include additional (or other) components than illustrated in FIG. 5.

Bus 510 may include a path that permits communication among the components of server 220. Processing logic 520 may include a processor, microprocessor, or other type of processing logic, such as an application-specific integrated circuit (ASIC), a field-programmable gate array (FPGA), etc., that may interpret and execute instructions. Main memory 530 may include a RAM or another type of dynamic storage device that may store information and instructions for execution by processing logic 520. ROM 540 may include a ROM device or another type of static storage device that may store static information and instructions for use by processing logic 520.

Storage device 550 may include a magnetic and/or optical recording medium and its corresponding drive. In one implementation, storage device 550 may include database 230 (FIG. 2). Storage device 550 may store program ranking information that may indicate most-watched programs for particular time slots. Storage device 550 may also store game ranking information that may indicate most-played games (e.g., online video games). In one implementation, storage device 550 may also store top programs and/or top games for particular categories that are determined by the subscription television provider. Types of categories for top programs may include, for example, content type (e.g., news, sports, movies, sitcoms, etc.), location (e.g., national, regional, city, household, etc.), viewing duration (e.g., most frequently view channel), etc. Types of categories for top games may include game types (e.g., sports, shooting, racing, strategy, etc.), target age groups, gender-specific games, etc.

Input device 560 may include a mechanism that permits an operator to input information to server 220, such as a keyboard, a mouse, a pen, voice recognition and/or biometric mechanisms, a touch-screen interface, etc. Output device 570 may include a mechanism that outputs information to the operator, including a display, a printer, a speaker, etc. Communication interface 580 may include any transceiver-like mechanism that enables server 220 to communicate with other devices and/or systems, such as set-top box 210.

As described herein, server 220 may perform certain operations to identify most-watched programming either generally or within particularly specified criteria and to provide information to STB 250. Server 220 may perform these and other operations in response to processing logic 520 executing software instructions contained in a computer-readable medium, such as main memory 530.

The software instructions may be read into main memory 530 from another computer-readable medium, such as storage device 550, or from another device via communication interface 580. The software instructions contained in main memory 530 may cause processing logic 520 to perform processes that will be described later. Alternatively, hardwired circuitry may be used in place of, or in combination with, software instructions to implement processes consistent with exemplary implementations. Thus, implementations described herein are not limited to any specific combination of hardware circuitry and software.

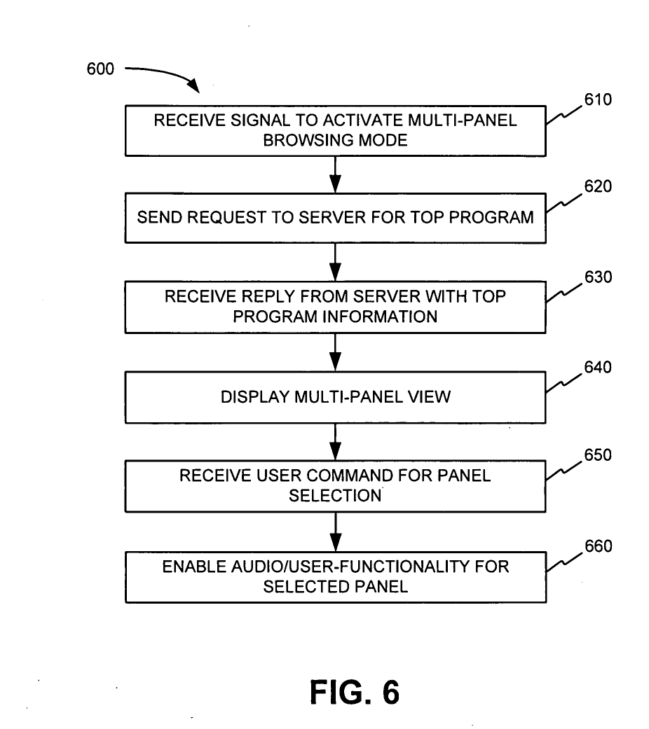

FIG. 6 provides a process flow 600 illustrating exemplary operations that may be performed by a set-top box to implement a multi-panel browsing mode on a display. For example, process flow 600 may be implemented by STB 250 to present a multi-panel display on television 260. Process 600 may begin with reception of a signal to activate a multi-panel browsing mode (block 610). For example, STB 250 may receive a signal from a remote control (e.g., remote control 270 of FIG. 2) to request the multi-panel browsing mode be activated.

A request may be sent to a server for a top program (block 620). For example, STB 250 may send a request message to server 220 to identify a most-watched program either generally or within a particular category. The request message may indicate the user's previously-stored input preference for a most-watched program category (e.g., the most-watched program during the timeslot when the request occurs) for a particular panel of the multi-panel browsing mode. In one implementation, the request message may include a second request for information for another panel of the multi-panel browsing mode. The second request may relate to information for interactive games. For example, the second request may include an indication of a most-played game to be displayed in another panel of the multi-panel display. In other implementations, the second request may relate to menu options for games, information for VOD programming (e.g., VOD previews, VOD menus, etc.) or other information available at server 220.

A reply from the server with the top program information may be received (block 630). For example, STB 250 may receive a reply from server 220 that includes the channel information for the program corresponding to the top program request. Thus, if the top program request is for the most-watched news program, STB 250 may receive from server 220 the channel number for the station in the subscriber's region that is carrying the most-watched news program at that time.

A multi-panel view may be displayed (block 640). For example, STB 250 may present a divided display area on television 260 that includes multiple panels. One panel may be considered a primary panel, such as primary panel 120 of FIG. 1, and may continue to display the channel previously being viewed on the full television screen by the user. A second viewing panel, such as second viewing panel 130 of FIG. 1, may be shown in another portion of the display of television 260. The second viewing panel may be automatically tuned to the channel corresponding to the top program information, which may be, for example, the most-watched news program at the current time. A third viewing panel, such as third viewing panel 130 of FIG. 1, may be shown in another portion of the display of television 260. The third viewing panel may automatically display another type of program or other multimedia content, based on criteria defined by a user or criteria by the subscription television service provider. In one implementation the third viewing panel may include a particular interactive game or an interactive game menu.

A user command for a panel selection may be received (block 650). For example, STB 250 may receive a command from a user via a remote control (such a remote control 270 of FIG. 2) to select a particular panel. In one implementation, the initial multi-panel browsing mode may maintain audio and channel tuning options for the primary panel (e.g., the panel displaying the channel previously being viewed on the full television screen by the user) when the multi-panel browsing mode is first displayed. Thus, a user may provide a command to toggle audio and/or other control options for a different panel. For example, a user may press one of function buttons “A,” “B,” or “C” on a remote control to choose among one of three windows in a multi-panel display. A single press of the “A,” “B,” or “C” button may be used to activate sound and/or other functionality for a panel, while a double-click (e.g., two presses on the same button within a particular time interval) may be used to select a particular panel and exit the multi-panel browser mode. As another example, a user may use other remote control features, such as arrows or numbers, to send a command to STB 250 to selectively toggle between panels of the multi-panel browsing mode.

Audio and/or user-functionality for a selected panel may be enabled (block 660). For example, based on the user command received in block 650, STB 250 may activate an audio signal corresponding to a panel in the multi-panel browsing mode that the user selected via the remote control command.

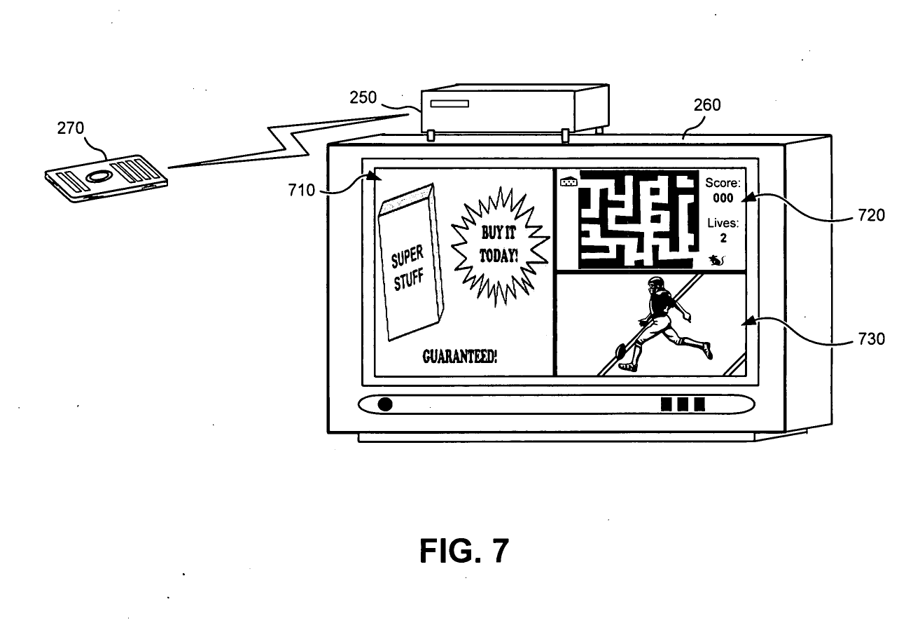

FIG. 7 is an exemplary diagram illustrating an implementation of multi-panel browsing according to systems and/or methods described herein. Referring to FIG. 7, a user may be watching a program on television 260 that receives programming content via STB 250. A user may activate a multi-panel browser mode at any time during the programming using, for example, remote control 270. In the example of FIG. 7, television 260 may be tuned to a program that is interrupted by a commercial, prompting a user to activate the multi-panel browsing mode by pressing a button on remote control 270.

Based on the command signal from remote control 270, STB 250 may divide the display of television 260 into multiple panels, shown in FIG. 7 as panels 710, 720, and 730. STB 250 may simultaneously review stored criteria for each panel and send a request to a remote server for program information and/or multimedia content consistent with the criteria. In the example of FIG. 1, the criteria for panel 710 may be to continue to show the current program; the criteria for panel 720 may be a favorite game of the user; and the criteria for panel 730 may be the most-watched sports program at the current time. STB 250 may shrink the display of the original programming (e.g., the commercial) to primary panel 710. In one implementation, STB 250 may adjust the aspect ratio of the programming displayed in panel 710 to accommodate the size of panel 710.

For panel 720, STB 250 may retrieve instructions for the user's favorite game. The instructions may be retrieved, for example, from a memory within STB 250 (such as memory 320 of FIG. 3) or from a remote server (such as server 220). STB 250 may display the game in panel 720.

For panel 730, STB 250 may receive a channel number from the server corresponding to the most-watched sports program at the current time. STB 250 may tune to the channel number and display the most-watched sports program in panel 730. The user may use remote control 270 to select which panel will have audio and/or other functionality.

In another implementation, each panel may provide access to multiple options within a category. For example, a top program panel, such as panel 730, may allow a user to browse through the top program for each of multiple genres. A user may select the top program panel (e.g., via remote control 270) and browse through top programs for particular categories by using, for example, left/right commands on remote control 270. Categories may include, for example, news, sports, cooking, movies, documentaries, comedy, etc. In one implementation, each top program may be displayed with a title to indicate the category of the top program (e.g., “Most-watch: Cooking.”

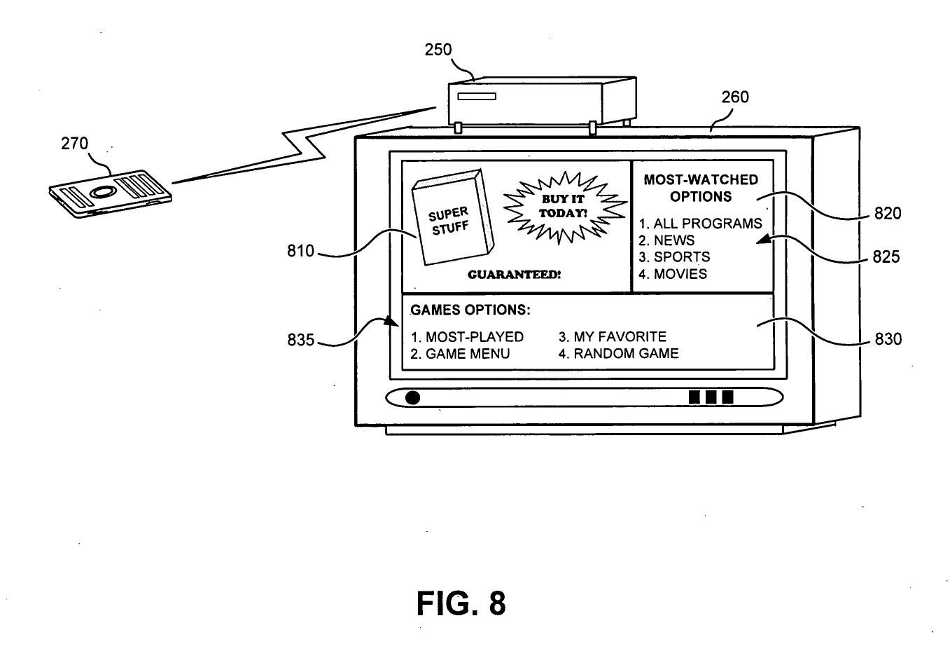

FIG. 8 is a diagram illustrating exemplary menu options for multi-panel browsing according to systems and/or methods described herein. Referring to FIG. 8, a user may use remote control 270 to interact with television 260 that receives programming content via STB 250. The user may provide criteria for panels of a multi-panel browser mode using, for example, remote control 270. As illustrated in FIG. 8, STB 250 may divide the display of television 260 into multiple panels 810, 820, and 830. Panels 810, 820, and 830 may be arranged on the display of television 260 with a variety of dimensions and/or aspect ratios. In one implementation, panel 810 may be designated as the primary panel and may not include a menu to accept alternate criteria.

Panel 820 may be designated as a top program panel. The user may select a category of programming for panel 820 from a menu, such as menu 825 displayed on television 260. Menu 825 may be displayed by, for example, first selecting panel 820 as the active panel (using, for example, a “B” function key on remote control 270) and then selecting a “menu” option from remote control 270. With menu 825 displayed, the user may select from, for example, options such as “All Programs,” “News,” “Sports,” and “Movies.” Based on the user's selection, when the multi-panel browsing mode is activated, STB 250 may tune to a most-watched program based on the viewing history of viewers. Menu 825 may also include sub-menus (not shown) for one or more options. A sub-menu may be implemented, for example, as a drop-down menu within menu 825 or as a separately displayed sub-menu. Ranking of programs may be based on statistics provided from a service-provider (e.g., provided via server 220). Rankings may be based on, for example, national statistics, regional statistics, or household statistics. In one implementation, a viewer may be provided with the opportunity (e.g. via menu 825 or a separate sub-menu) to identify the base group (e.g., national, regional, or household) for determining the most-watch programming.

Panel 830 may be designated as a games panel. The user may select a category of information for panel 830 from a menu, such as menu 835 displayed on television 260. Similar to panel the description above with respect to panel 820, menu 835 may be displayed by first selecting panel 830 as the active panel (using, for example, a “C” function key on remote control 270) and then selecting the “menu” option from remote control 270. With menu 835 displayed, the user may select from, for example, options such as “Most-Played,” “Game Menu,” “May Favorite,” and “Random Game.” Based on the user's selection, when the multi-panel browsing mode is activated, STB 250 may display either a menu or a particular game corresponding to the selected menu option.

Systems and/or methods described herein may display program content from a subscription television service on a display and receive a signal to initiate a multi-panel browsing mode on the display. A set-top box may send to a server a top program request for the subscription television service and receive top program information from the server. The top program information may include a channel number for a top program at a time associated with the request. The set-top box may generate a multi-panel view on the display, the multi-panel view including a panel with the program content and a panel with the top program based on the top program information received from the server. Additional panels may be included in the multi-panel view, such as interactive games or other content available from the subscription television service.

The foregoing description provides illustration and description, but is not intended to be exhaustive or to limit the implementations to the precise form disclosed. Modifications and variations are possible in light of the above teachings or may be acquired from practice of systems and/or methods disclosed herein.

Also, while a series of blocks has been described with regard to the flowchart of FIG. 6, the order of the blocks may differ in other implementations. Further, non-dependent acts may be performed in parallel.

It will be apparent that implementations, as described herein, may be implemented in many different forms of software, firmware, and hardware in the implementations illustrated in the figures. The actual software code or specialized control hardware used to implement implementations described herein is not limiting of the invention. Thus, the operation and behavior of the implementations were described without reference to the specific software code—it being understood that software and control hardware may be designed to implement the implementations based on the description herein.

Further, certain implementations described herein may be implemented as “logic” that performs one or more functions. This logic may include hardware—such as a processor, microprocessor, an application specific integrated circuit or a field programmable gate array—or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method, comprising:
displaying program content from a subscription television service on a display;
receiving a signal to initiate a multi-panel browsing mode on the display;
sending, to a server, a top program request for the subscription television service;
receiving top program information from the server based on the top program request, the top program information including a channel number for a top program at a time associated with the top program request; and
displaying a multi-panel view on the display, the multi-panel view including a panel with the program content and a panel with the top program based on the top program information received from the server.

2. The method of claim 1, further comprising:
receiving a user command for a panel selection to activate an audio signal for the selected panel.

3. The method of claim 1, where the multi-panel view further comprises a panel with game-related content.

4. The method of claim 1, further comprising:
sending, to the server, a request for game information for the subscription television service; and
receiving the game information from the server based on the request for game information, where the multi-panel view further includes a panel with the game information.

5. The method of claim 1, where a signal to initiate the multi-panel browsing mode is received from a remote control.

6. The method of claim 1, where the top program is a most-watched program during the time of the top program request.

7. The method of claim 1, where the top program request indicates a programming content category.

8. The method of claim 1, further comprising:
receiving input from a user to identify criteria for one or more panels of the multi-panel view.

9. A system, comprising:
a server to distribute multimedia content and viewing data for a subscription television service over a network;
a television to display the multimedia content;
a set-top box to receive the multimedia content and the viewing data, the set-top box including a processor to:
send, to the server, a request to identify a top program at the time of the request, receive top program information from the server based on the request, and
display a multi-panel view on the television, the multi-panel view including a panel to display a top program based on the top program information and a panel to display a separate program.

10. The system of claim 9, where the request to identify the top program at the time of the request is initiated based on a user command to activate a multi-panel browsing mode.

11. The system of claim 9, where the processor further:
sends, to the server, a request to for game-related content,
receives the game-related content from the server based on the request for the game-related content, and
displays a panel that includes the game-related content.

12. The system of claim 9, further comprising:
a remote control configured to send a signal to the set-top box to initiate the multi-panel view.

13. The system of claim 9, where the remote control is further configured to send a user command for a panel selection that activates an audio signal for the selected panel.

14. The system of claim 9, where the top program is a most-watched program at the time of the request.

15. The system of claim 9, where the processor further:
receives user input to identify criteria for the top program, where the request to identify the top program is based on the criteria.

16. The system of claim 15, where the set-top box further comprises:
a memory to store the user input to identify criteria for the top program.

17. The system of claim 9, where the multi-panel view further includes a panel to display one of randomly generated channels or previews for video-on-demand programming.

18. A system, comprising:
means for displaying program content from a subscription television service;
means for receiving a signal to initiate a multi-panel browsing mode on the means for displaying;
means for sending, to a server, a top program request for the subscription television service;
means for receiving top program information from the server based on the top program request, the top programming information including a channel number for a top program at a time associated with the top program request;
means for generating game-related content; and
means for displaying a multi-panel view on the display, the multi-panel view including a panel with the program content, a panel with the top program, and a panel with a game based on the game-related content.

19. The system of claim 17, further comprising:
means for receiving user input to identify criteria for a category of the top program.

20. The system of claim 19, further comprising:
means for storing the user input, where the top program request is based on the user input.
